(19) United States
(12) Patent Application Publication
(10) Pub. No.: US 2026/0121535 A1
(43) Pub. Date: Apr. 30, 2026

(54) BOOST CIRCUIT AND LIGHTING DEVICE

(71) Applicant: SHENZHEN BILLDA TECHNOLOGY CO.,LTD, SHENZHEN (CN)

(72) Inventors: JIANJUN KE, SHENZHEN (CN); WEICHANG WU, SHENZHEN (CN); PEIZHI CHEN, SHENZHEN (CN); QIU FENG, SHENZHEN (CN)

(21) Appl. No.: 18/941,244

(22) Filed: Nov. 8, 2024

(30) Foreign Application Priority Data
Aug. 14, 2024 (CN) 202421977535.X

(51) Int. Cl. H02M 3/158; H02M 1/34; H05B 45/38

(52) U.S. Cl. CPC H02M 3/158; H02M 1/34; H05B 45/38

(57) ABSTRACT

The invention provides a boost circuit and a lighting device. A controller is electrically connected to a first terminal of a switch transistor, a first terminal of a voltage sampling circuit and a first terminal of a current sampling circuit, a third terminal of the switch transistor is electrically connected to a second terminal of the current sampling circuit, and a second terminal of the voltage sampling circuit is electrically connected to an inductor. The voltage sampling circuit and the current sampling circuit respectively acquire an output voltage and an output current and feed the output voltage and the output current back to the controller to enable the controller to adjust a drive control signal to stabilize the output voltage at a set voltage value, such that a stable supply voltage is provided for a load.

### BACKGROUND OF THE INVENTION

### 1. Technical Field

The invention relates to the technical field of circuits, in particular to a boost circuit and a lighting device.

### 2. Description of Related Art

In a power module of an emergency lighting device, an AC-DC conversion module is often used to convert an input alternating current into a direct current to supply power to an LED unit. Generally, the DC voltage output by the AC-DC conversion module can satisfy the requirement for a standard supply voltage, but it cannot satisfy the requirement for a higher supply voltage. So, it is necessary to boost the voltage output by the AC-DC conversion module. In the related art, a boost module typically comprises an inductor and a switch transistor; after the number of turns of the inductor is set, the switch transistor is controlled to be turned on or off to boost the voltage. By adopting such a structure, the output voltage may fluctuate with an input voltage, a load or an environmental condition, and it cannot be ensured that a stable boosted voltage is provided for a load device, thus affecting normal operation of the load device.

### BRIEF SUMMARY OF THE INVENTION

The invention provides a boost circuit and a lighting device to solve the problem of poor stability of the output voltage of boost modules in the related art.

To solve the above technical problem, in a first aspect, the invention provides a boost circuit, comprising a controller, an inductor, a switch transistor, a voltage sampling circuit and a current sampling circuit, wherein the controller is electrically connected to a first terminal of the switch transistor, a first terminal of the voltage sampling circuit and a first terminal of the current sampling circuit, the inductor is electrically connected to a power supply and a second terminal of the switch transistor and is configured to be electrically connected to an external load, a third terminal of the switch transistor is electrically connected to a second terminal of the current sampling circuit, and a second terminal of the voltage sampling circuit is electrically connected to the inductor.

Further, the current sampling circuit comprises a first resistor and a second resistor, one terminal of the first resistor is electrically connected to the third terminal of the switch transistor and one terminal of the second resistor, the other terminal of the first resistor is grounded, and the other terminal of the second resistor is electrically connected to a current detection terminal of the controller.

Further, the voltage sampling circuit comprises a third resistor, a fourth resistor, a fifth resistor and a snubber circuit, one terminal of the third resistor is electrically connected to the inductor and one terminal of the snubber circuit, the other terminal of the third resistor is electrically connected to one terminal of the fourth resistor, the other terminal of the fourth resistor is electrically connected to one terminal of the fifth resistor, the other terminal of the snubber circuit and a feedback voltage input terminal of the controller, and the other terminal of the fifth resistor is grounded.

Further, the boost circuit further comprises a first triode, a second triode and a seventh resistor, wherein a first terminal of the first triode is electrically connected to the power supply, a second terminal of the first triode is electrically connected to the seventh resistor and a first terminal of the second triode, a third terminal of the first triode is electrically connected to a second terminal of the second triode and the first terminal of the switch transistor, a third terminal of the second triode is grounded, and the other terminal of the seventh resistor is electrically connected to an output terminal of the controller.

Further, the boost circuit further comprises a rectifier and filter circuit and a first diode, wherein one terminal of the rectifier and filter circuit is electrically connected to the inductor, the other terminal of the rectifier and filter circuit is configured to be electrically connected to the external load, a positive pole of the first diode is electrically connected to the power supply, and a negative pole of the first diode is electrically connected to the rectifier and filter circuit.

In a second aspect, the invention provides a lighting device, comprising the boost circuit in the first aspect of the invention.

From the above description, the controller provides a drive control signal for the switch transistor; when the switch transistor is turned on, the inductor boosts a voltage and outputs the boosted voltage to the external load, and then the voltage sampling circuit and the current sampling circuit respectively acquire an output voltage and an output current and feed the output voltage and the output current back to the controller to enable the controller to adjust the drive control signal so as to ensure that the output voltage is stabilized at a preset voltage value, such that a stable and reliable supply voltage is provided for the load.

### BRIEF DESCRIPTION OF THE SEVERAL VIEWS OF THE DRAWINGS

FIG. 1 is a schematic structural diagram of a boost circuit according to one embodiment of the invention;

FIG. 2 is a schematic circuit diagram of the boost circuit according to one embodiment of the invention;

FIG. 3 is a schematic circuit diagram of a voltage stabilizing circuit according to one embodiment of the invention;

FIG. 4 is a schematic circuit diagram of the boost circuit according to another embodiment of the invention.

### DETAILED DESCRIPTION OF THE INVENTION

To gain a better understanding of the purposes, technical solutions and advantages of the invention, the invention is described in further detail below in conjunction with accompanying drawings and embodiments, and identical or similar reference signs indicate identical or similar elements or elements with identical or similar functions throughout the description. It should be understood that the specific embodiments described here are merely used for explaining the invention and are not used for limiting the invention. In addition, the technical features involved in the following embodiments of the invention can be combined without conflicts.

In view of the problem of poor stability of the output voltage of boost modules in the related art, one embodiment of the invention provides a boost circuit.

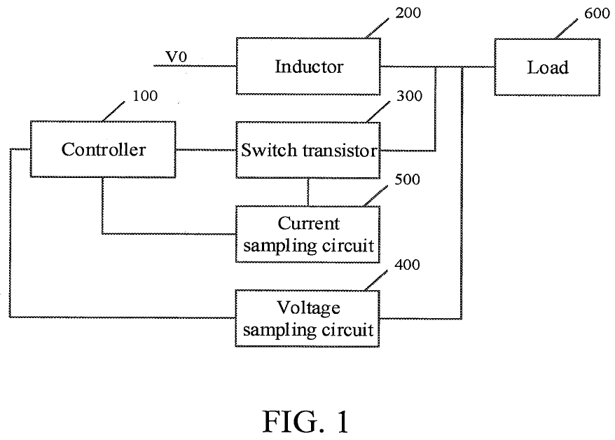

As shown in FIG. 1 which is a schematic structural diagram of a boost circuit according to one embodiment of the invention, the boost circuit comprises: a controller 100, an inductor 200, a switch transistor 300, a voltage sampling circuit 400 and a current sampling circuit 500, wherein the controller 100 is electrically connected to a first terminal of the switch transistor 300, a first terminal of the voltage sampling circuit 400 and a first terminal of the current sampling circuit 500, the inductor 200 is electrically connected to a power supply V0 and a second terminal of the switch transistor 300 and is configured to be electrically connected to an external load 600, a third terminal of the switch transistor 300 is electrically connected to a second terminal of the current sampling circuit 500, and a second terminal of the voltage sampling circuit 400 is electrically connected to the inductor 200.

Specifically, in this embodiment, the controller 100 is used for outputting a drive signal to the switch transistor 300 to enable the switch transistor 300 to be turned on and off periodically according to the drive signal; in each on-off cycle, when the switch transistor 300 is turned on, the inductor 200 stores energy to increase an output voltage; when the switch transistor 300 is turned off, the inductor 200 releases energy and transmits the energy to the external load 600 such as an LED unit. The voltage sampling circuit 400 is used for acquiring an output voltage, transmitting the output voltage to the controller 100, and comparing the output voltage with a reference voltage in an error amplifier in the controller 100 to generate a control voltage to adjust the duty cycle or pulse width of a drive signal so as to control the on-time of the switch transistor 300 to regulate the output voltage. The current sampling circuit 500 is used for acquiring an output current, converting the output current into a voltage and then transmitting the voltage to the controller 100, and the controller 100 adjusts the duty cycle or pulse width of a drive control signal according to the feedback voltage. In this way, two sampling circuits are used for feedback to stabilize an output boosted voltage at a set voltage value so as to provide a reliable supply voltage for the external load 600.

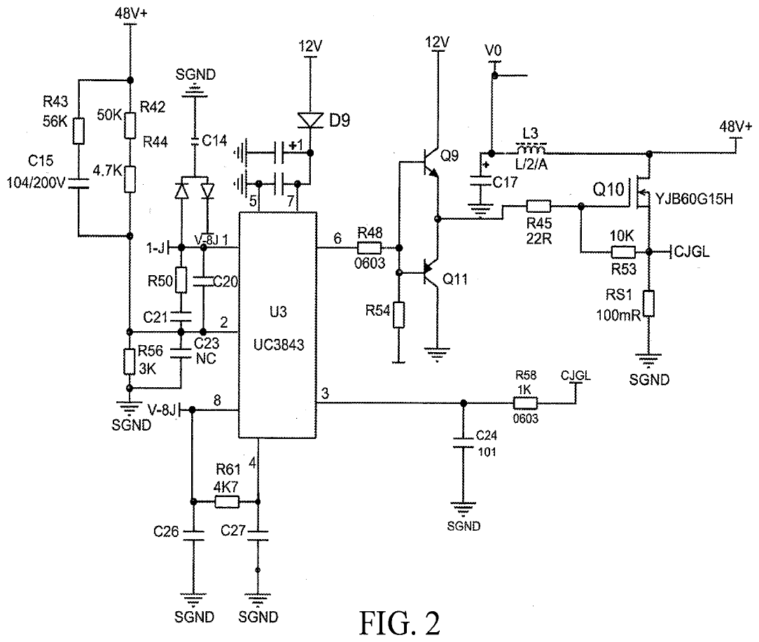

Referring to FIG. 2 which is a schematic circuit diagram of the boost circuit according to this embodiment, the current sampling circuit 500 comprises a resistor RS1 and a second resistor R58, wherein one terminal of the first resistor RS1 is electrically connected to the third terminal of the switch transistor 300 (Q10) and one terminal of the second resistor R58, the other terminal of the first resistor RS1 is grounded, and the other terminal of the second resistor R58 is electrically connected to a current detection terminal of the controller 100 (U3).

Further, referring to FIG. 2, the voltage sampling circuit 400 comprises a third resistor R42, a fourth resistor R44, a fifth resistor R56 and a snubber circuit, wherein one terminal of the third resistor R42 is electrically connected to the inductor 200 and one terminal of the snubber circuit, the other terminal of the third resistor R42 is electrically connected to one terminal of the fourth resistor R44, the other terminal of the fourth resistor R44 is electrically connected to one terminal of the fifth resistor R56, the other terminal of the snubber circuit and a feedback voltage input terminal of the controller U3, and the other terminal of the fifth resistor R56 is grounded. The snubber circuit comprises a sixth resistor R43 and a first capacitor C15, wherein the sixth resistor R43 is electrically connected to one terminal of the third resistor R42 and one terminal of the first capacitor C15, and the other terminal of the first capacitor C15 is electrically connected to the other terminal of the fourth resistor R44.

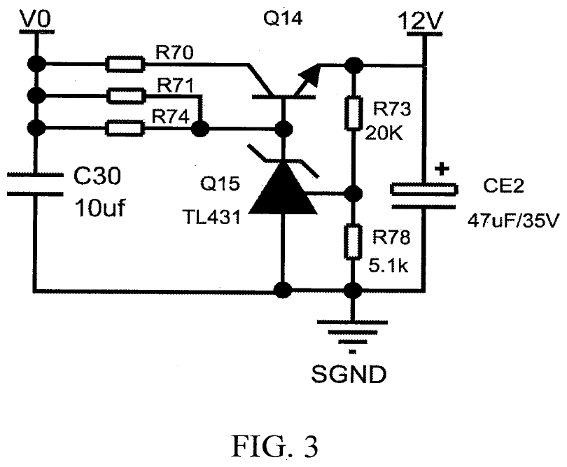

Specifically, in this embodiment, the controller U3 may be a UC3843 controller 100, the switch transistor Q10 may be, for example, an NMOS transistor as shown in FIG. 2, the current sampling circuit 500 samples a current by means of the first resistor RS1 and the second resistor R58, convers the current into a voltage and transmits the voltage to the current detection terminal 3 of the controller 100, the voltage sampling circuit 400 divides and samples a output boosted voltage by means of the third resistor R42, the fourth resistor R44 and the fifth resistor R56 and then transmits the voltage to the feedback voltage input terminal 2 of the controller U3, and after the voltage is compared with a reference voltage by the controller U3, the duty cycle or pulse width of an output drive signal is adjusted to control the on-time of the switch transistor Q10 to stabilize an output voltage, for example, when the potential of the feedback voltage input terminal is increased, the duty cycle of the drive signal output by the controller U3 will be decreased, and the output voltage will be decreased accordingly. In this embodiment, the input power supply is V0, and the output boosted voltage is 48V. In addition, it should be noted that a pin 1 of the controller U3 in FIG. 2 is an output of the error amplifier, is connected to a pin 2 (the feedback voltage input terminal) and a compensation network (a capacitor C21, a capacitor C21 and a resistor R50), and is used for determining the response frequency of a control loop of the controller U3 to ensure the stability of a feedback circuit; a pin 4 is an oscillation terminal and is connected to a constant-frequency resistor R61 and constant-frequency capacitors C26 and C27, a pin 5 is a ground terminal, a pin 8 is a reference voltage output terminal and is used for outputting a 5V reference voltage, a pin 7 is a power terminal and is able to convert an input voltage V0 into a supply voltage required by the controller U3, such as a 12 V voltage, by means of a voltage stabilizing circuit and stabilize the supply voltage at 12V, and as shown in FIG. 3, the voltage stabilizing circuit comprises a stabilivolt Q15 and a triode Q14, wherein the stabilivolt is used for providing a reference voltage source and controlling an output of the triode according to the feedback voltage to regulate the output voltage.

Further, referring to FIG. 2, the boost circuit further comprises a first triode Q9, a second triode Q11 and a seventh resistor R48, wherein a first terminal of the first triode Q9 is electrically connected to the power supply, a second terminal of the first triode Q9 is electrically connected to the seventh resistor R48 and a first terminal of the second triode Q11, a third terminal of the first triode Q9 is electrically connected to a second terminal of the second triode Q11 and the first terminal of the switch transistor Q10, a third terminal of the second triode Q11 is grounded, and the other terminal of the seventh resistor R48 is electrically connected to an output terminal of the controller U3.

Further, referring to FIG. 2, the boost circuit further comprises an eighth resistor R45 and a ninth resistor R53, wherein one terminal of the eighth resistor R45 is electrically connected to the first terminal of the switch transistor 300, the other terminal of the eighth resistor R45 is electrically connected to the third terminal of the first triode Q9, and the ninth resistor R53 is electrically connected to the first terminal and the third terminal of the switch transistor Q10.

Specifically, in this embodiment, the first triode Q9 and the second triode Q11 are respectively an NPN triode and a PNP triode, and the first triode Q9, the second triode Q11 and the seventh resistor R48 form a totem-pole structure used for amplifying the drive signal output by the controller U3. The eighth resistor R45 and the ninth resistor R53 may be used for providing bias voltages for MOS transistors to ensure that the MOS transistors operate within a normal range and prevent ESD to avoid electrostatic damage when a high resistance exists between a gate and a source, thus guaranteeing the safety of a device.

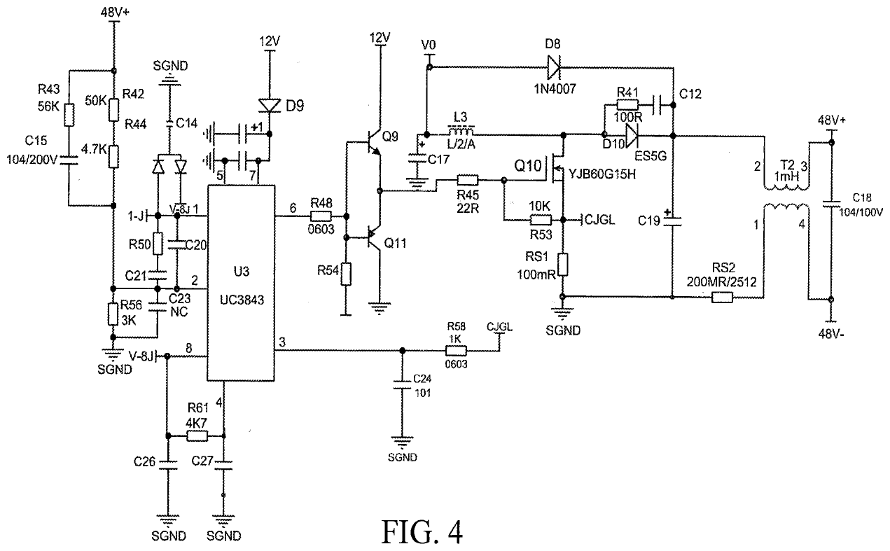

Referring to FIG. 4 which is a schematic structural diagram of the boost circuit according to another embodiment of the invention, the boost circuit further comprises a rectifier and filter circuit and a first diode D8, wherein one terminal of the rectifier and filter circuit is electrically connected to the inductor 200 (L3), the other terminal of the rectifier and filter circuit is electrically connected to the external load, a positive pole of first diode D8 is electrically connected to the power supply Vo, and a negative pole of the first diode D8 is electrically connected to the rectifier and filter circuit.

Specifically, the rectifier and filter circuit comprises a second diode D10, a second capacitor C19, a common-mode choke T2, a third capacitor C18 and a tenth resistor RS2, wherein a positive pole of the second diode D10 is electrically connected to the inductor L3, a negative pole of the second diode D10 is electrically connected to a first terminal of the common-mode choke T2 and the negative pole of the first diode D8, one terminal of the second capacitor C19 is electrically connected to the negative pole of the second diode D10, the other terminal of the second capacitor C19 is grounded, a second terminal of the common-mode choke T2 is electrically connected to one terminal of the tenth resistor RS2, a third terminal and a fourth terminal of the common-mode choke T2 are electrically connected to the external load, the other terminal of the tenth resistor RS2 is grounded, and the third capacitor C18 is electrically connected to the third terminal and the fourth terminal of the common mode choke T2. The rectifier and filter circuit further comprises a fourth capacitor C12 and an eleventh resistor R41, wherein the eleventh resistor R41 is electrically connected to the positive pole of the second diode D10 and one terminal of the fourth capacitor C12, and the other terminal of the fourth capacitor C12 is electrically connected to the negative pole of the second diode D10.

Specifically, in this embodiment, the boost circuit boosts a voltage, then rectifies and filters the voltage and finally transmits the voltage to the external load, wherein the second diode D10 is used for rectifying the output voltage, and the fourth capacitor C12 and the eleventh resistor R41 form an RC absorption circuit that can divide and absorb a peak voltage to reduce the peak voltage so as to guarantee the stability and reliability of the second diode D10; and the second capacitor C19, the common-mode choke T2, the third capacitor C18 and the tenth resistor RS2 are used for filtering. In addition, the boost circuit further comprises the first diode D8, and the first diode D8 is connected in parallel to the inductor L3 and can prevent the inductor L3 from being fully charged in case of a short circuit of the second capacitor C19.

According to the boost circuit provided by the embodiments of the invention, the controller provides a drive control signal for the switch transistor; when the switch transistor is turned on, the inductor boosts a voltage and outputs the boosted voltage to the external load, and then the voltage sampling circuit and the current sampling circuit respectively acquire an output voltage and an output current and feed the output voltage and the output current back to the controller to enable the controller to adjust the drive control signal so as to ensure that the output voltage is stabilized at a preset voltage value, such that a stable and reliable supply voltage is provided for the load.

One embodiment of the invention further provides a lighting device, comprising the boost circuit described above. Wherein, the lighting device may be an emergency lamp.

It should be noted that the embodiments of the application are described progressively, the differences of each embodiment from other embodiments are emphatically described, and the similarities between different embodiments can be referred to mutually.

It should also be noted that relational terms “first” and “second” in the invention are merely used for distinguishing one entity or operation from the other entity or operation and do not definitely require or imply that an actual relationship or sequence exists between these entities or operations. In addition, terms “comprise” and “include” or any other variants intend to indicate non-exclusive inclusion, so a process, method, article or device comprising a series of elements not only comprises the elements that are clearly listed, but also comprises other elements that are not clearly listed or comprises inherent elements of the process, method, article or device. Unless otherwise further defined, an element defined by “comprise one . . . ” shall not exclude other identical elements in a process, method, article or device comprising said element.

With reference to the description of the above embodiments, those skilled in the art can implement or use the application. Various modifications of these embodiments will be obvious for those skilled in the art, and the general principle defined by the contents of the application can be implemented in other embodiments without departing from the spirit or scope of the application. Therefore, the application will not be limited to the embodiments illustrated here and has a broadest range in conformity with the principle and novel features disclosed by the application.

What is claimed is:

1. A boost circuit, comprising a controller, an inductor, a switch transistor, a voltage sampling circuit and a current sampling circuit, wherein the controller is electrically connected to a first terminal of the switch transistor, a first terminal of the voltage sampling circuit and a first terminal of the current sampling circuit, the inductor is electrically connected to a power supply and a second terminal of the switch transistor and is configured to be electrically connected to an external load, a third terminal of the switch transistor is electrically connected to a second terminal of the current sampling circuit, and a second terminal of the voltage sampling circuit is electrically connected to the inductor.

2. The boost circuit according to claim 1, wherein the current sampling circuit comprises a first resistor and a second resistor, one terminal of the first resistor is electrically connected to the third terminal of the switch transistor and one terminal of the second resistor, the other terminal of the first resistor is grounded, and the other terminal of the second resistor is electrically connected to a current detection terminal of the controller.

3. The boost circuit according to claim 1, wherein the voltage sampling circuit comprises a third resistor, a fourth resistor, a fifth resistor and a snubber circuit, one terminal of the third resistor is electrically connected to the inductor and one terminal of the snubber circuit, the other terminal of the third resistor is electrically connected to one terminal of the fourth resistor, the other terminal of the fourth resistor is electrically connected to one terminal of the fifth resistor, the other terminal of the snubber circuit and a feedback voltage input terminal of the controller, and the other terminal of the fifth resistor is grounded.

4. The boost circuit according to claim 3, wherein the snubber circuit comprises a sixth resistor and a first capacitor, the sixth resistor is electrically connected to one terminal of the third resistor and one terminal of the first capacitor, and the other terminal of the first capacitor is electrically connected to the other terminal of the fourth resistor.

5. The boost circuit according to claim 1, further comprising a first triode, a second triode and a seventh resistor, wherein a first terminal of the first triode is electrically connected to the power supply, a second terminal of the first triode is electrically connected to the seventh resistor and a first terminal of the second triode, a third terminal of the first triode is electrically connected to a second terminal of the second triode and the first terminal of the switch transistor, a third terminal of the second triode is grounded, and the other terminal of the seventh resistor is electrically connected to an output terminal of the controller.

6. The boost circuit according to claim 5, further comprising an eighth transistor and a ninth resistor, wherein one terminal of the eighth resistor is electrically connected to the first terminal of the switch transistor, the other terminal of the eighth transistor is electrically connected to the third terminal of the first triode, and the ninth resistor is electrically connected to the first terminal and the third terminal of the switch transistor.

7. The boost circuit according to claim 1, further comprising a rectifier and filter circuit and a first diode, wherein one terminal of the rectifier and filter circuit is electrically connected to the inductor, the other terminal of the rectifier and filter circuit is configured to be electrically connected to the external load, a positive pole of the first diode is electrically connected to the power supply, and a negative pole of the first diode is electrically connected to the rectifier and filter circuit.

8. The boost circuit according to claim 7, wherein the rectifier and filter circuit comprises a second diode, a second capacitor, a common-mode choke, a third capacitor and a tenth resistor, a positive pole of the second diode is electrically connected to the inductor, a negative pole of the second diode is electrically connected to a first terminal of the common-mode choke and the negative pole of the first diode, one terminal of the second capacitor is electrically connected to a negative pole of the second diode, the other terminal of the second capacitor is grounded, a second terminal of the common-mode choke is electrically connected to one terminal of the tenth resistor, a third terminal and a fourth terminal of the common-mode choke are electrically connected to the external load, the other terminal of the tenth resistor is grounded, and the third capacitor is eclectically connected to the third terminal and the fourth terminal of the common-mode choke.

9. The boost circuit according to claim 8, wherein the rectifier and filter circuit further comprises a fourth capacitor and an eleventh resistor, the eleventh resistor is electrically connected to the positive pole of the second diode and one terminal of the fourth capacitor, and the other terminal of the fourth capacitor is electrically connected to the negative pole of the second diode.

10. A lighting device, comprising the boost circuit according to claim 1.
